(19) United States
(12) Patent Application Publication
(10) Pub. No.: US 2008/0320139 A1
(43) Pub. Date: Dec. 25, 2008

(54) SOCIAL MOBILIZED CONTENT SHARING

(75) Inventors: Matthew K. Fukuda, San Francisco, CA (US); Cynthia Johanson, San Francisco, CA (US); Scott Gatz, San Francisco, CA (US); Daniel James Wascovich, San Francisco, CA (US); Michael Quoc, San Francisco, CA (US); Eric Fixler, Oakland, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/767,776

(22) Filed: Jun. 25, 2007

(51) Int. Cl. G06F 15/173

(52) U.S. Cl. 709/226

(57) ABSTRACT

A mobile device, system, and method are directed towards identifying and employing social agents within a social network for distribution of multimedia content virally over mobile devices. The social agent may identify one or more multimedia content items for distribution. The social agent may also identify recipients of the viral distributions, or the recipients may be automatically identified based on the social network. The recipients may receive a message that enables them to access a playlist of the social agent's multimedia content. The playlist may be associated with a card display that displays information about the social agent on one side. The recipient may then ‘flip’ the card to display the playlist. Playing of a selection in the playlist may then enable the social agent to receive a reward. The recipient may also distribute the social agent's playlist to another recipient, thus virally distributing multimedia content within the social network.

### TECHNICAL FIELD

The present invention relates generally to mobile communications and, more particularly, but not exclusively to enabling a mobile device user to share multimedia information based, at least in part, on employing a social agent to create and leverage a social network to distribute multimedia content among users of the social network.

### BACKGROUND

Tremendous changes have also been occurring in the Internet that influence our everyday lives. For example, online social networks have become the new meeting grounds. They have been called the new power lunch tables and new golf courses for business life in the U.S. Moreover, many people are using such online social networks to reconnect themselves to their friends, their neighborhood, their community, and the world.

The development of such online social networks touch countless aspects of our everyday lives, providing instant access to people of similar mindsets, and enabling us to form partnerships with more people in more ways than ever before.

One aspect of our everyday lives that may benefit from online social networking technology is sharing of multimedia information for people on the go. Sharing of multimedia information has become prevalent on mobile devices and has changed our everyday lives. Mobile devices, such as digital cameras, video recorders, PDAs, and cell-phones, increasingly, have become enabled with wireless data connectivity. Users are able to send and receive multimedia information from these mobile devices more readily. However, today, many users cannot easily identify relevant sources of, and/or recipients for, their multimedia information. Moreover, the ability to obtain sharable multimedia remains complicated, often requiring cumbrous actions by the user to locate, access, and/or share the multimedia information with another person. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention;

FIG. 4 illustrates a logical flow diagram generally showing one embodiment of a process for sharing of multimedia information within a social network; and

FIG. 5 shows one embodiment of a screen shot useable for multimedia sharing cards on a mobile device; and

FIG. 6 shows one embodiment of a use case illustrating various screen shots of sharing cards useable in sharing multimedia content, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “social network” and “social community” refer to a concept that an individual's personal network of friends, family colleagues, coworkers, and the subsequent connections within those networks, can be utilized to find more relevant connections for a variety of activities, including, but not limited to dating, job networking, service referrals, content sharing, like-minded individuals, activity partners, or the like.

An online social network typically comprises a person's set of direct and/or indirect personal relationships, including real and virtual privileges and permissions that users may associate with these people. Direct personal relationships usually include relationships with people the user can communicated with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship, and so forth.

Moreover, the term “social networking information,” refers to both dynamic as well as less dynamic characteristics of a social network. Social networking information includes various profile information about a member, including, but not limited to the member's avatar, contact information, the member's preferences, age, gender, degrees of separation between the member and another member, a membership in an activity, group, or the like. For example, social networking information may also include information about a member's contacts, the member's music preferences, or the like. Moreover, social networking information may also include information about a member's network communication's plan, including whether the member has an unlimited data transfer plan, text plan, or the like.

Social networking information further may include various information about a communications between the member and other members in the social network, including, but not limited to emails, SMS messages, IM messages, Multimedia Message (MMS) messages, alerts, audio messages, phone calls, either received or sent by the member, or the like.

Various “meta-data” may also be associated with the social networking information. Thus, for example, various permissions for access may be associated with at least some of the social networking information. Some access permissions (or sharing rules) may be selected, for example, based, in part, on an input by the member, while other access permissions may be defaulted based on other events, constraints, or the like. For example, in one embodiment, some social networking meta-data my indicate whether the member allows sharing of their age, and/or home location to one or more other members, while not allowing sharing of the same or other information to one or more different other members.

The term “multimedia content,” as used herein refers to information, including content, comprising graphical, textual, video, audio, or links to such content. Multimedia content may include images, video, animation, audio files, or the like. For example, in one embodiment multimedia content may include information about music content, video content, or the like. In one embodiment, multimedia content may include a link, such as a hyperlink, or the like, to a playable multimedia content. In still another embodiment, multimedia content includes the content files themselves, including audio files, video files, graphical files, text files, or the like, independent of their format. The term “multimedia information” refers to text, graphics, images, or the like, that are associated with the multimedia content, including, but not limited, to ratings data, avatars, images, or the like, label information, multimedia name, or the like. In one embodiment, multimedia information may include multimedia content.

Briefly stated the present invention is directed towards identifying and employing social agents within a social network to enable distribution of multimedia content virally over mobile devices. Based in part on social networking member's profile, a member may be selected as a social agent. However, the invention is not limited to a social agent being selected. For example, in one embodiment, an advertisement may be viewed by a variety of multimedia users, and one or more of the recipients of the advertisement may select to pro-actively become social agents.

The social agent may be provided with an incentive for creating an initial viral distribution of the multimedia content. In one embodiment, the social agent may identify one or more multimedia content items for distribution. In one embodiment, the social agent may receive a downloaded viral distribution application for use in identifying, managing, and virally distributing multimedia content. In one embodiment, the social agent may uniquely identify one or more recipients of the viral distributions. In another embodiment, the social agent's social network, user profile, or the like, may be employed to automatically identify the recipients. In one embodiment, an n-th degree of separation may be used to identify the recipients, where n is an integer greater than zero. For example, in one embodiment, first-degree of separations, group membership, members within a defined activity, or the like, may be automatically used to identify recipients of the distributions. In another embodiment, the social agent may identify recipients for sharing of the multimedia content, even if the identified recipient may not currently be within the social agent's current on-line social network.

In one embodiment, the recipient may receive a message, such as an SMS message, IM message, or the like. The message may enable the recipient to access a playlist that indicates the social agent's multimedia content. In one embodiment, the playlist may include links to or otherwise include the multimedia content. In one embodiment, the recipient may download the viral distribution application with the playlist. In one embodiment, the viral distribution application may receive and manage the playlist. The playlist may be associated with a sharing card for the social agent, such as described more below. The sharing card may include an ability to display multiple ‘sides’ of the card. For example, in one embodiment, the sharing card may display an avatar, name, or the like, of the social agent. The recipient may then ‘flip’ the sharing card to display or otherwise enable access to the playlist. In one embodiment, the ‘sides’ of the sharing card may be further partitioned for various types of multimedia content. For example, one side might display a music playlist, while another side might display a video playlist, or the like. In one embodiment, the sharing card enables the recipient to select and play a selection within the playlist. Playing of the selection may then enable the social agent to receive a reward. The recipient might also create their own playlist, include some of the social agent's selections in their playlist, including ringtones, photographs, music, videos, or the like. The recipient may also select to distribute the social agent's playlist to another recipient, distribute a modified social agent's playlist, or even distribute their own playlist, thus virally sharing multimedia content within a social network. In one embodiment, the recipient may also receive a reward for sharing the social agent's playlist, their playlist, or the like. In one embodiment, the members of the social network might identify multimedia content on their playlists, which could then result in a sort-of social network's super playlist, accessible to each of the members of the social network.

### Illustrative Operating Environment

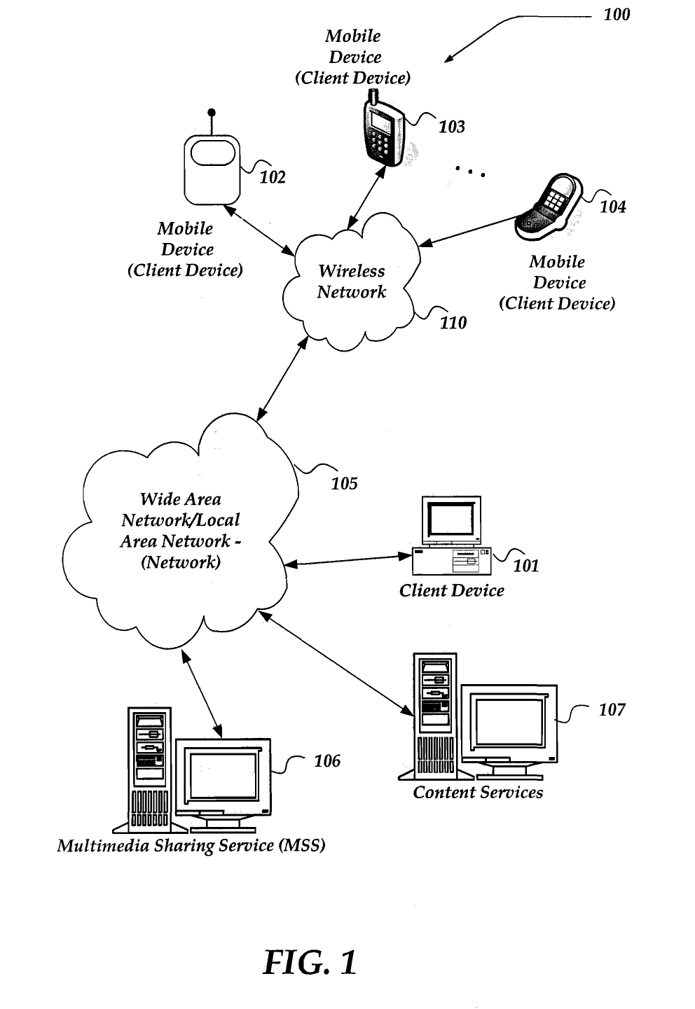

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, Multimedia Sharing Service (MSS) 106, mobile devices (client devices) 102-104, client device 101, and content services 107.

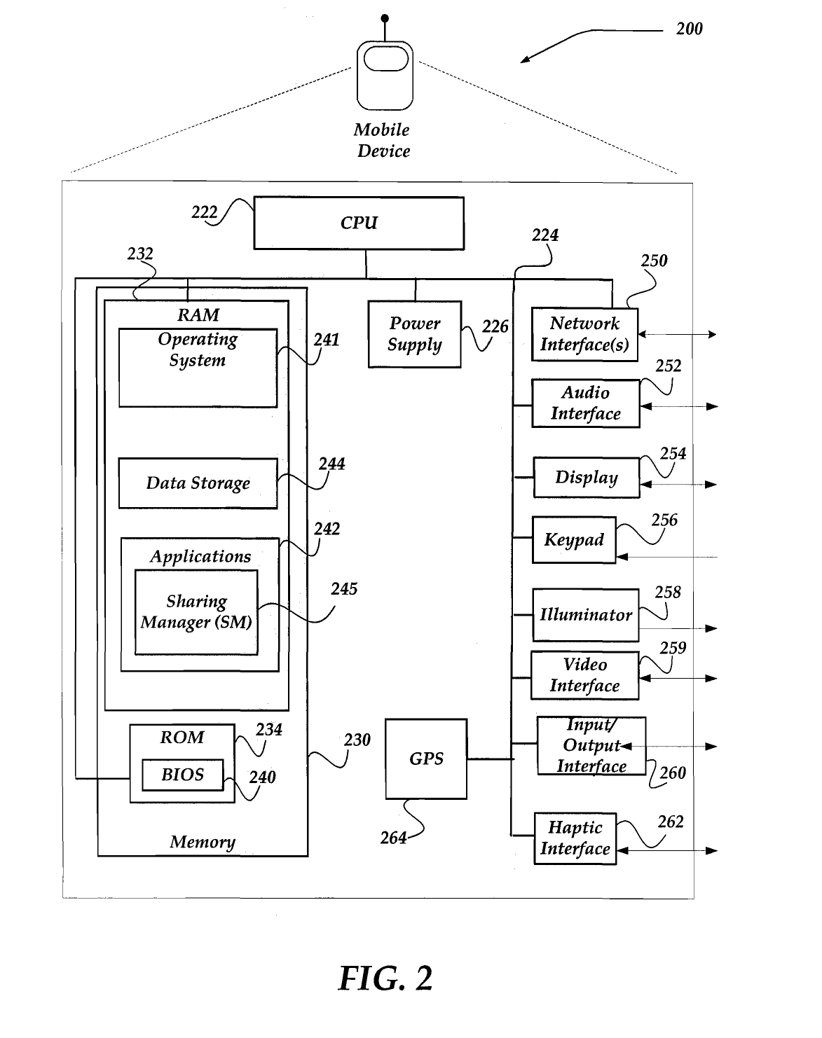

One embodiment of mobile devices 102-103 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), extensible Markup Language (XML), or the like, to display and send a message.

Mobile devices 102-104 also may include at least one other client application that is configured to receive content from another computing device. The client application may include a capability to provide and receive textual content, multimedia information, or the like. The client application may further provide information that identifies itself, including a type, capability, name, or the like. In one embodiment, mobile devices 102-104 may uniquely identify themselves through any of a variety of mechanisms, including a phone number, Mobile Identification Number (MIN), an electronic serial number (ESN), network address, or other device identifier. The information may also indicate a content format that the mobile device is enabled to employ. Such information may be provided in a message, or the like, sent to MSS 106, client device 101, or other computing devices.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, or the like, between another computing device, such as MSS 106, client device 101, or the like. However, the present invention is not limited to these message protocols, and virtually any other message protocol may be employed.

Mobile devices 102-104 may be further configured to enable a user to participate in communications sessions, such as message sessions. As such, mobile devices 102-104 may include a client application that is configured to manage various actions on behalf of the client device useable in various messaging activities. For example, the client application may enable a user to interact with the browser application, email application, IM applications, SMS application, or the like.

Mobile devices 102-104 may further be configured to include a client application that enables the end-user to log into an end-user account that may be managed by another computing device, such as MSS 106. Such end-user account, for example, may be configured to enable the end-user to receive emails, send/receive IM messages, SMS messages, access selected web pages, participate in a social networking activity, or the like. However, participation in various social networking activities may also be performed without logging into the end-user account.

In addition, mobile devices 102-104 may include another application that is configured to enable the mobile user to share and/or receive multimedia information/content, and to display multimedia sharing cards useable in sharing and accessing multimedia information/content. In one embodiment, the application may be downloaded onto a mobile device, for example, over networks 105 and 110 from MSS 106, content services 107, or the like. In one embodiment, each of mobile devices 102-104 may share with and/or receive the multimedia information/content from MSS 106 and/or from another one of mobile devices 102-104. In conjunction with sharing multimedia information/content, mobile devices 102-104 may enable an interaction with each other, through sharing various multimedia playlists, multimedia sharing cards, and generally participating in a variety of integrated social experiences beyond merely voice communications or text messages (e.g., IM). In one embodiment, mobile devices 102-104 may enable the interaction with a user associated with received multimedia information/content.

Mobile devices 102-104 may also communicate with non-mobile client devices, such as client device 101, or the like. In one embodiment, such communications may include participation in social networking activities, including sharing of multimedia information.

Client device 101 may include virtually any computing device capable of communicating over a network to send and receive information, including social networking information, multimedia sharing cards, and/or other multimedia content/information, or the like.

The set of such devices may include devices that typically connect using a wired communications medium such as personal computers, multiprocessor systems, microprocessor-based or programmable consumer electronics, network PCs, or the like. Similarly, client device 101 may include one or more applications as described above in conjunction with mobile devices 102-104.

Wireless network 110 is configured to couple mobile devices 102-104 and its components with network 105. Wireless network 110 may include any of a variety of wireless sub-networks that may further overlay stand-alone ad-hoc networks, or the like, to provide an infrastructure-oriented connection for mobile devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, or the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), or the like. In essence, wireless network 110 may include virtually any wireless communication mechanism by which information may travel between mobile device s 102-104 and another computing device, network, or the like.

Network 105 is configured to couple MSS 106 and its components with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between MSS 106, client device 101, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as twisted pair, coaxial cable, fiber optics, wave guides, and other wired media and wireless media such as acoustic, RF, infrared, and other wireless media.

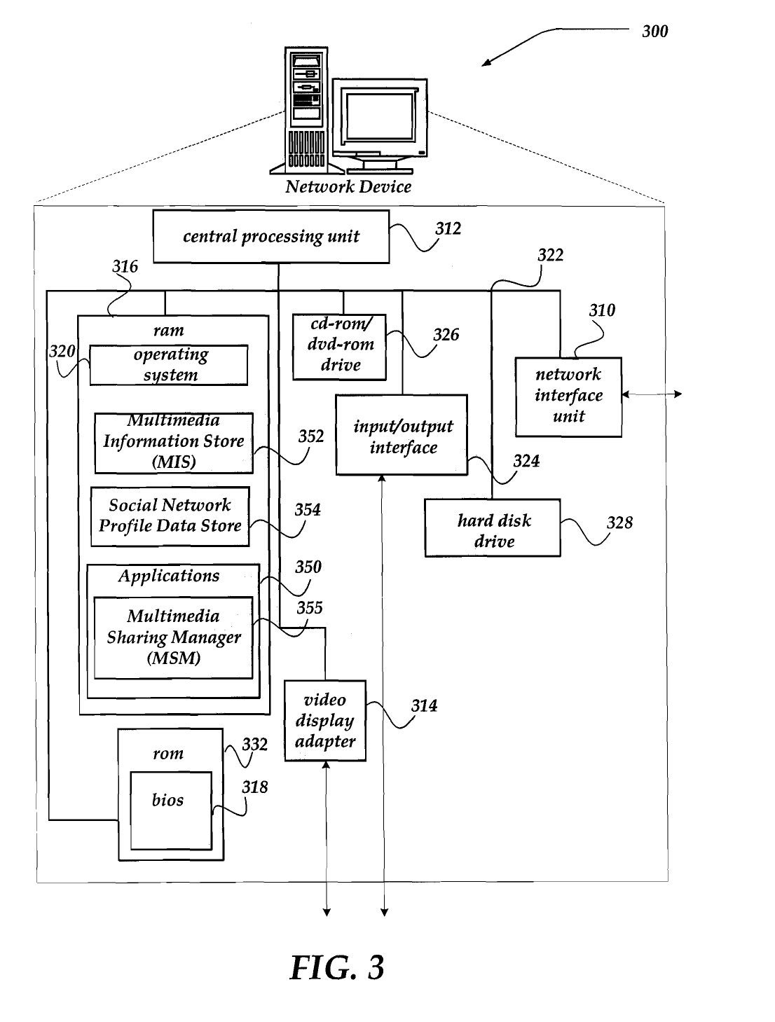

One embodiment of MSS 106 is described in more detail below in conjunction with FIG. 3. Briefly, however, MSS 106 may include any computing device capable of connecting to network 105 to enable sharing of multimedia information/content using multimedia sharing cards, multimedia playlists, and/or other social networking information. MSS 106 may manage a playlist for different multimedia content for a user of client devices 101-104. In one embodiment, the user may further enable MSS 106 to monitor and/or manage other social networking information of the user, including, but not limited to personal information, such as age, name, gender, personal preferences; a friends list, a buddy list, a messaging address list, or the like. MSS 106 may also be configured and arranged to monitor a user's on-line activities, including, for example, how often the user plays a particular multimedia content, tells a friend about a particular multimedia content, or the like. MSS 106 may also obtain information about a user of one or more of client devices 101-104 from another network device. For example, another network device may provide information about a user's communication plan, including whether the user has purchased selected communication options such as unlimited text messaging, multimedia services, or the like.

MSS 106 may employ information about users of client devices 101-104 to select users to operate as social agents for virally distributing multimedia content. A social agent may be virtually any person, or entity, that tends to socially share multimedia content, and/or information about multimedia content with other users. A social agent may be active or passive. For example, in one embodiment, the active social agent may be an entity or person that proactively seeks out and shares multimedia information and/or content with others. Typically, the active social agent provides the multimedia content, and/or a link to the multimedia content, to others. A passive social agent may include a website, blog page, or the like, that becomes sufficiently popular by various other communications that users seek it out to access multimedia content and/or information.

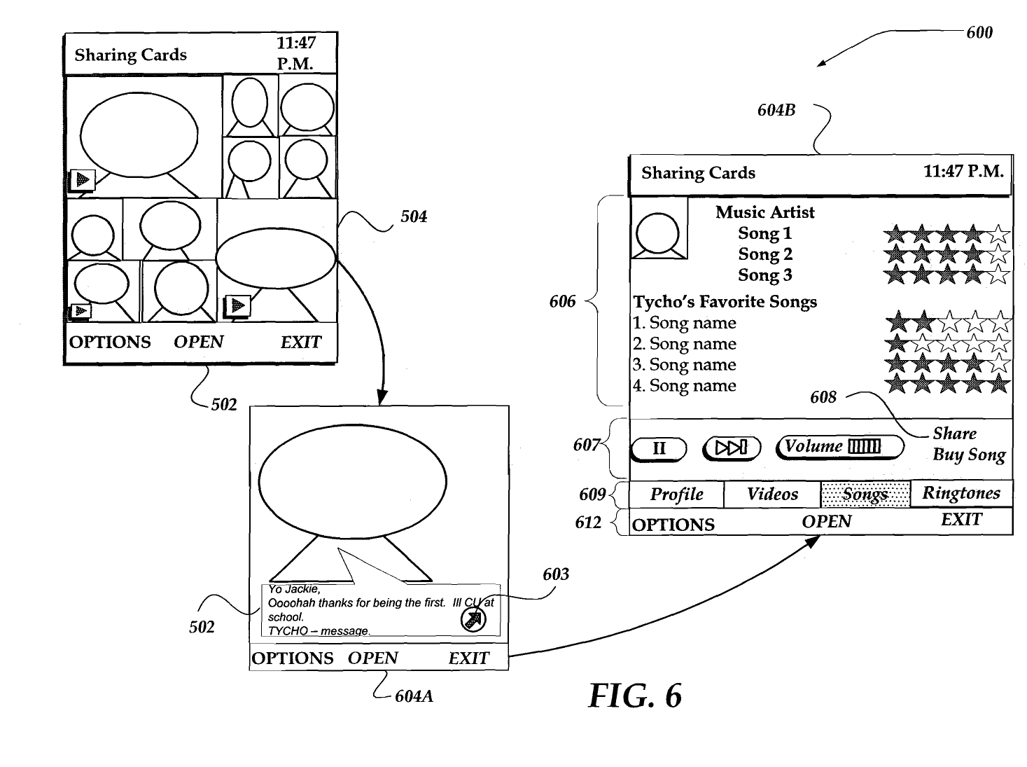

In any event, MSS 106 may provide to one or more social agents an application that enables the social agent to readily manage playlists. Management of the playlists may be performed automatically by MSS 106 by adding, deleting, and/or ranking of playlists. Briefly, a playlist, or multimedia playlist includes a listing of multimedia content. However, a playlist may also comprise a plurality of multimedia content files, including such as MP3 files, video files, audio files, graphical files, or the like. One example of a display of a playlist is illustrated in FIG. 6 described in more detail below.

The application may further enable the social agent to readily share the playlist, or even a portion of the playlist with others. In one embodiment, MSS 106 may monitor whether the social agent shares at least a portion of the playlist, whether a recipient plays a selection from the playlist, and/or whether the recipient proceeds to share at least a portion of the received playlist with yet another user. MSS 106 may then, based on a defined rule, provide a reward to the social agent for such actions by the social agent, and/or by the recipient(s) of the social agent's playlist (or portion thereof). A reward may include, for example, a monetary reward, access to additional multimedia content at a reduced price, or even free, a reduction in a telecommunication plan's fee, or the like. However, rewards are not limited to these examples, and any of a variety of other rewards may be provided without departing from the scope of the invention.

Devices that may operate as MSS 106 include personal computers desktop computers, multiprocessor systems, microprocessor-based or programmable consumer electronics, network PCs, servers, or the like.

Although FIG. 1 illustrates MSS 106 as a single computing device, the invention is not so limited. For example, one or more functions of MSS 106 may be distributed across one or more distinct computing devices. For example, managing various social networking activities, including sharing of multimedia information, managing social agents, rewarding of social agents, aggregating and/or storing of social networking information, or the like, may be performed by a plurality of computing devices, without departing from the scope or spirit of the present invention.

Content services 107 represents a variety of service devices that may provide multimedia information and/or content for use by client devices 101-104. Content services 107 may also provide the multimedia content using a variety of mechanisms, including through websites, FTP access, database services, streaming services, or the like. Devices that may operate as content services 107 include personal computers desktop computers, multiprocessor systems, microprocessor-based or programmable consumer electronics, network PCs, servers, or the like.

### Illustrative Mobile Client Environment

FIG. 2 shows one embodiment of mobile device 200 that may be included in a system implementing the invention. Mobile device 200 may include many more or less components than those shown in FIG. 2. However, the components shown-are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store multimedia information and/or social networking information including address lists, contact lists, personal preferences, or the like. Data storage 244 may also include multimedia content. At least a portion of the multimedia information, multimedia content, and/or social networking information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may further include sharing manager (SM) 245.

In one embodiment, SM 245 may be an application downloadable onto mobile device 200. SM 245 may in one embodiment, include a playlist. For example, where information about multimedia content played by a user of mobile device 200 is known by another network device, such as content service 107, MSS 106, or the like, such information may be employed to generate and include the playlist with SM 245. In another embodiment, SM 245 may include a default playlist based on social networking information known to the other network device about the user, or the like. SM 245 may also be configured as a script, applet, application, or the like, that may operate within another application, such as a web browser, or the like. In still another embodiment, SM 245 may also include a link, script, applet, or the like, that enables access to an application, or the like, that may be remotely located to mobile device 200.

SM 245 may enable the user of mobile device 200 to play, rate, provide comments about, or otherwise manage the playlist, including adding and/or deleting items from the playlist. In one embodiment SM 245 may automatically manage the playlist by adding, deleting, and/or providing a rating of an item based on actions by the user. For example, where the user plays, by either downloading, viewing, and/or streaming multimedia content on mobile device 200, SM 245 may include the multimedia content onto the playlist. SM 245 may place the multimedia content onto the playlist based on a type or category of content, such as video, music, graphic, or the like. SM 245 may also select to place the multimedia content onto the playlist if the user plays, or otherwise accesses that particular multimedia content item, or a substantially similar item, a defined number of times. For example, in one embodiment where the playlist might be initially empty, a single access by the user might be sufficient to have the item automatically added to the playlist. In another embodiment, however, multiple accesses might be the criterion before an item is added to the playlist. However, it should be clear that items may be automatically added, and/or even deleted based on any of a variety of criteria. Thus, these examples are not intended to limit the invention in any manner. Thus, for example, if an item on the playlist is not played or otherwise accessed for some period of time, SM 245 may automatically delete the item. However, in another embodiment, items might be deleted based on maintaining a defined size of the playlist, or the like. Items might also be ranked automatically by SM 245 based on a number of times the item is accessed. SM 245 may also be configured to enable the user to manually manage the playlist, including adding/deleting, and/or rating and/or ranking of items within the playlist.

SM 245 further enables the user of mobile device 200 to share at least a portion of the playlist with another user, and/or receive and play items from another's playlist. SM 245 may, in one embodiment, enable the user to identify one or more recipients with which to share the playlist. In one embodiment, the user may be enabled to select from a list of potential recipients, identify a criteria for automatically selecting potential recipients, or the like. For example, the user might indicate that the potential recipients include first-degree of separation social users based on the user's social network. In another example, the user might indicate select to send the playlist to those that are within a geographic distance from the user and within the user's contact list. In still another example, the user might select a type of user within their social network, such as family, school friends, members within a group, activity, or the like, to automatically send the playlist. The invention is not constrained, however, to these examples, and virtually any criteria or mechanism may be used to select the potential recipients. For example, in one embodiment the user may be enabled to directly enter/select one or more recipients by name, alias, or the like. In one embodiment SM 245 may enable the user to provide a short message to the recipient.

In one embodiment, SM 245 may provide a message to the determined recipients indicating that the user wants to share a playlist with them. In one embodiment, the message is an SMS message. However, other messaging protocols may also be used, including, email, IM, or the like. In one embodiment, the message may include a link, or information indicating how to access the playlist. In one embodiment, the recipient may be able to select the link and receive the playlist. In another embodiment, when the recipient selects the link, the recipient might have downloaded a version of SM 245 onto their network device. In one embodiment, a copy of the playlist might be included with the download. In another embodiment, the playlist may reside on a remote network. In one embodiment, a copy of the playlist may be made accessible to the recipient at the remote network device. Thus, in one embodiment, the playlist might be managed remotely, rather than locally on mobile device 200.

SM 245 may further collect and/or provide information to another network device indicating whether the user of mobile device 200 shares at least a portion of the user's playlist with another user. In one embodiment, the user might receive a reward for sharing their playlist with another user.

SM 245 may provide a user interface such as described below in conjunction with FIG. 6 to enable the user to access, manage, receive, and/or share playlists. In one embodiment, the user interface employs a multimedia sharing card concept for use in managing playlist. As described below, SM 245 may enable the user to receive and manage several playlists, from several other users.

It should be noted, however, that while SM 245 is described as a downloadable application, the invention is not so limited. For example, SM 245 may be a script, applet, or the like, that may be configured to operate within another application or the like. In one embodiment, SM 245 may represent a link useable through a browser, or the like, to access a remote user interface for managing and sharing multimedia content.

### Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, MSS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Social Network Profile Data Store (SNPDS) 354 and/or Multimedia Information Store (MIS) 352 may be included in mass memory, while, Multimedia Sharing Manager (MSM) 355 may also be included within applications 350.

Multimedia Information Store (MIS) 352 stores a plurality of received multimedia information. For example, in one embodiment, MIS 352 may store and manage user's multimedia playlists. MIS 352 may also include multimedia content, and/or multimedia information, including links to playlists, links to multimedia content, or the like. In one embodiment, MIS 352 may be a database, a file structure, or the like. MIS 352 may store the multimedia information into a category structure, such as folders, albums, graphs, trees, or the like.

SNPDS 354 is configured to receive from a variety of sources information that may be associated with social networking activities of various social networking members. Such information may include but is not limited to various communications, including emails, SMS messages, IM messages, audio messages, VOIP messages, RSS feeds, membership information, calendar events, photo streams, photographs, blog updates, web pages, mood information, behaviors of social network members, download patterns, download selections, music selections, video selections, purchase patterns, or the like. SNPDS 354 may also include a variety of user profile information, including, but not limited to age, name, alias, account information, gender, multimedia preferences, information about their communications plan, or the like. SNPDS 354 may also include information about with whom a user may communicate, including contact lists, buddy lists, email address books, or the like. SNPDS 354 may be implemented as a database, a folder, program, or the like.

MSM 355 is configured to select one or more social agents and enable the social agents to virally share multimedia content. Based in part on the sharing, playing, purchasing, or similar activities by the recipients of the shared multimedia content, MSM 355 may then elect to provide a reward to the social agent. Such rewards may be based on a variety of factors, and/or constraints. Thus, for example, a social agent may be enabled to share and/or receive a reward for sharing a multimedia content item not more than a defined number of times. Such limitation may be directed for example, towards minimizing spamming, and/or other types of abuse of the reward mechanism. Such limitation may also be based on license agreements, or the like. Moreover, a reward might, in one embodiment, be in terms of accumulated points, or the like. For example, in one embodiment a social agent might receive N points for multimedia content items shared directly by the social agent, and receive M<N points for those same multimedia content items shared by the recipient to yet another user. Such points may then be employed to provide various rewards to the social agent, including, but not limited, to a reduced price access to additional multimedia content, reduction in costs for their communication plan, or the like. The invention is not so limited however, and virtually any reward for virally sharing of the multimedia content may be employed, without departing from the scope of the invention.

In one embodiment, MSM 355 may also provide to a user's client device a downloadable application, such as described above in conjunction with FIG. 2. In one embodiment, the downloaded application may include a shared playlist. However, a link, or the like, may also be provided to enable access to the playlist.

MSM 355 may also enable a client device to send a message to another user that enables the other user to download the application, obtain access to a playlist, and or the like.

In one embodiment, MSM 355 may also manage a super playlist that may be configured and managed by a plurality of users. For example, the super playlist may include a subset of the plurality of users' playlists. For example, where a subset of the content items within the user's playlist has exceeded a defined rating, the subset may be provided to MSM 355 for inclusion into the super playlist. However, the super playlist may also be managed based on a variety of other selection/deletion criteria, without departing from the scope of the invention.

### Generalized Operation

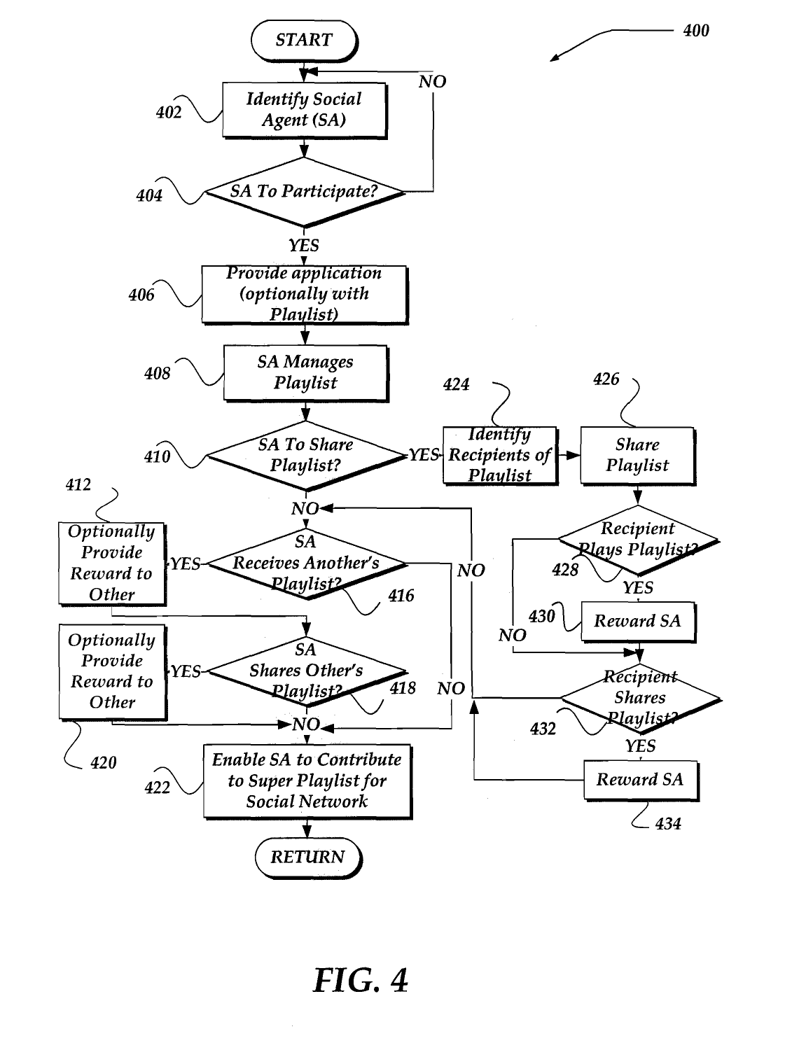

The operation of certain aspects of the invention will now be described with respect to FIG. 4. FIG. 4 illustrates a logical flow diagram generally showing one embodiment of a process for sharing of multimedia information within a social network. Process 400 of FIG. 4 may be implemented within MSS 106 of FIG. 1, for example.

Process 400 begins, after a start block, at block 402, where social agent(s) may be identified. Such identification may, in one embodiment, be based on a user profile, a user's communication plan, a user's on-line behavior, a user's social networking interaction, size, an amount of sharing of multimedia content that the social agent has done within a defined period of time, or the like. However, the identification need not be limited to these examples, and a social agent may be identified based on virtually any criteria. For example, in one embodiment, a solicitation may be provided seeking social agents. One or more of the responders to the solicitation may then be identified as a social agent.

Processing may next move to decision block 404, where a determination is made whether an identified social agent elects to participate. In one embodiment, a message may be sent to the potential social agent seeking their participation, identifying a reward structure for participation or the like. In any event, if the potential social agent elects not to participate, process 404 may loop back to block 402 to identify another potential social agent.

Otherwise, processing continues to block 406, where the social agent may be provided with a client application such as described above for use in virally sharing multimedia content. In one embodiment, the client application may include a playlist based on the social agent's actions, a default playlist, or the like. In one embodiment, the client application may include a link to the playlist, where the playlist is managed remote from the client device.

Processing flows next to block 408, where the social agent may then manage their playlist by adding, deleting, and/or rating multimedia content items. Process 400 flows next to decision block 410, where a determination is made whether the social agent selects to share at least a portion of their playlist. If so, processing branches to block 424; otherwise, processing continues to decision block 416.

At block 424, recipients of the social agent's playlist may be identified based on a variety of criteria, including those described above. For example, the recipients may be automatically identified based on the social agent's online behaviors, the social agent's social network, or the like. The recipients may also be manually identified by the social agent. In one embodiment, the social agent may compose a message that may be sent to one or more of the identified recipients.

Moving to block 426, a message may then be sent to the recipients indicating that the social agent's playlist is available. The message may be sent as an SMS message, IM message, email message, MMS message, or the like. In one embodiment, the message may include a mechanism to access the social agent's playlist, including a link to the playlist, a link to the downloadable application that enables access to the playlist, or the like. In one embodiment, the recipient may select the link, or the like, to access the downloadable application and/or playlist. In one embodiment, the recipient may be provided a sharing card of the social agent, such as described below, that enables the user to then access the social agent's playlist.

Continuing to decision block 428, a determination is made whether the recipient plays an item within the social agent's playlist. If so, processing moves to block 430; otherwise, processing branches to decision block 432. At block 430, a reward may be allotted to the social agent, such as described above. Processing continues to decision block 432.

At decision block 432, a determination is made whether the recipient selects to share the social agent's playlist with another user. If so, processing proceeds to block 434, where the social agent may be rewarded based on such viral sharing. Processing then branches to decision block 416. Similarly, if the recipient elects not to share the social agent's playlist, processing continues to decision block 416. It should be noted, that the recipient may also, at any time, continue to play the social agent's playlist, share the playlist, and/or even create their own playlist, contribute to a super playlist, or the like. Thus, several actions of the recipients may be represented by various blocks within process 400, without departing from the scope of the invention. For example, the recipient may be a social agent also, elect to become a social agent, or the like.

In any event, at decision block 416, a determination is made whether the social agent receives a playlist from another user. As mentioned above, the social agent might receive a playlist from another social agent. Thus, if so, processing may branch to block 412, where the other user may receive a reward for sharing their playlist with the social agent. Processing then flows to decision block 418. However, if the social agent does not receive another's playlist, processing branches to block 422.

At decision block 418, a determination is made whether the social agent selects to share the other's playlist with yet another user. Selection of the other user(s) may be based on substantially similar criteria as employed at block 424, above. However, in one embodiment, the social agent may also employ different criteria, without departing from the scope of the invention. In any event, processing continues block 420, if the social agent elects to share the other's playlist. At block 420, the other user may optionally receive a reward. Processing then flows to block 422.

At block 422, based on a variety of criteria, a super playlist may also be made accessible to the social agent, and/or others within the social agent's social network. The super playlist may be managed based on contributions, and/or other input from the social agent and/or other others. For example, as mentioned above, the super playlist may be based on “top” rated content items within members of the social network's playlists. In any event, processing may then return to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Use Case and Sharing Cards

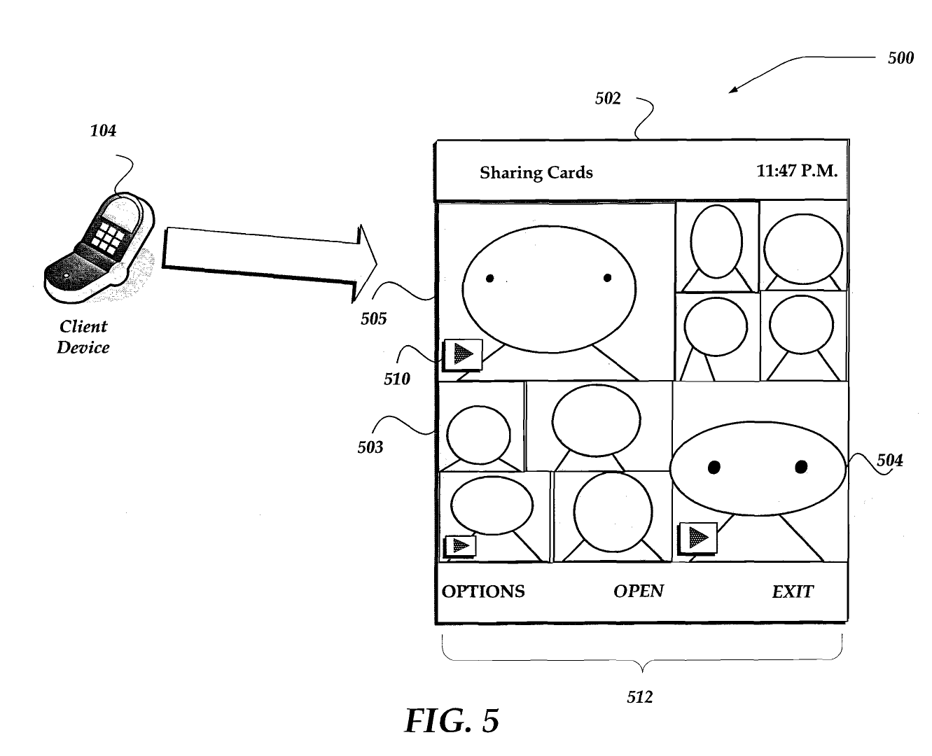

Possible embodiments of sharing cards useable in virally sharing of multimedia content will now be described within the context of one possible use case. It should be noted that the following illustrations and use case are not intended to limit the invention. Instead, they are intended to merely provide an understanding of how the invention may be employed. Thus, FIG. 5 shows one embodiment of a screen shot useable for multimedia sharing cards on a mobile device.

As shown in FIG. 5, configuration 500 includes an illustration of a possible mobile device 104 that may be configured and arranged to enable access to one or more sharing cards as shown in screen shot 502.

Screen shot 502 illustrates a plurality of sharing cards, including, sharing cards 503-505. As seen, sharing cards 503-505 may illustrate an avatar, photograph, a name, an alias, or the like, of a sender associated with the sharing card. Such sharing cards are configured to enable the user of client device 104 to access a playlist associated with the sender of the sharing card. As shown, a sharing card, such as sharing card 505 may include a message selector 510 that enables the mobile device user to play a message from the sender. Such message may be an audio message, a video message, or even a text message.

In one embodiment, display of received sharing cards 503-505 may be configured such that the sharing cards may be grouped, or organized by the mobile device user. In one embodiment, the sharing cards may be automatically resized to enable a plurality of sharing cards to be displayed within a single screen display. In another embodiment, the mobile device user may be enabled to resize and/or relocate, rearrange, and even delete sharing cards. In one embodiment, screen shot 502 may be configured such that the sharing cards may be scrollable within a window.

As shown, in screen shot 502, the mobile device user may be provided with commands 512 that enables the mobile device user to exit the application, select various management options, or open a selected sharing card. Selection of a sharing card may be performed by clicking on the sharing card (double clicking the sharing card, might, for example, enable the sharing card to be opened), or the like.

FIG. 6 shows one embodiment of a use case illustrating various screen shots of sharing cards useable in sharing multimedia content. As shown use case 600 may include many more or less components than those shown in FIG. 6. However, the components shown are sufficient to disclose an illustrative embodiment for practicing the present invention.

As shown, use case 600 includes screen shot 502, and an expansion of different sides of sharing card 504. Such different sides of sharing card 504 include first side 604A and second side 604B.

When a mobile device user selects sharing card 504, the screen may display, in one embodiment, one side of the selected sharing card—here as first side 604A. Clearly, other arrangements may also be displayed. For example, in one embodiment, a rotating sharing card might be displayed, wherein the sharing card rotates about an axis, and the user may click on a particular side of the card for further examination.

In any event, as illustrated, first side 604A may include, in addition, to an avatar, photograph, or the like, a message 502 that is provided by the sender of the sharing card 504. In one embodiment, the message 502 may also be a video message, an audio message, or the like. In one embodiment, selection of indicator 603 may enable the user to view/hear, and/or expand message 502.

In addition, the user may select to view another side of the sharing card 604A using one of the commands provided. Selection of another side of the sharing card may, in one embodiment, provide second side 604B.

As shown, second side 604B may display the sender's playlist 606, play commands 607, and sharing card commands 612. As shown the sender's playlist 606 may include a rating of multimedia content items, a listing of or links to multimedia content items within playlist 606, or the like. Playlist 606 may also include one or more of the multimedia content items, including, but not limited to an audio file, video file, graphical file, or the like. In one embodiment, additional multimedia content information may also be provided, including, but not limited to an artist's name, photograph, avatar, or the like. In one embodiment, the mobile device user may select to click on the rating information within playlist 606 to modify it.

Second side 604B may also include side tabs 609 to enable ready access to other sides of the sharing card. Thus, as illustrated side tabs 609 may enable the sender to participate multimedia content and other information based on categories, including a sender's profile (as might be illustrated in first side 604A), videos, songs, ringtones, or the like. It should be noted that the invention is not constrained to these categories, and virtually any category may be employed to partition and manage multimedia content and information within a sharing card.

Play commands 607 enables the mobile device user to pause, play, stop, rewind, modify a volume, or the like, for a selected multimedia content item. Selection of the multimedia content item within playlist 606 may be performed, in one embodiment, by double clicking on the listed item, clicking on the item and selecting an open command with sharing card commands 612, or the like. In one embodiment, play commands 607 may include a share command 608 that enables the mobile device user to share the playlist, a modified version of the playlist, or even to share the mobile device user's own playlist (depending, in one embodiment, upon what playlist is illustrated within playlist 606).

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A processor readable medium that includes data and instructions, wherein the execution of the instructions on a computing device provides for managing multimedia content over a network by enabling actions, comprising:
identifying at least one social agent based in part on a profile, or an online behavior;
providing to the social agent an application useable to manage a playlist;
identifying a recipient for the playlist based in part on a social network associated with the recipient and the social agent;
automatically sharing the playlist with the recipient, wherein the playlist is embodied within a sharing card;
if the recipient plays at least one multimedia content item indicated within the playlist, providing the social agent with a reward; and
if the recipient shares at least part of the social agent's playlist with another member of the social network, providing the social agent with another reward.

2. The processor readable medium of claim 1, wherein the sharing card further comprises a displayable n-sided card that is arranged and configured to display on a network device the playlist for at least one of music, ringtones, photographs, or videos.

3. The processor readable medium of claim 1, wherein the sharing card further comprises at least one side of a displayable n-sided card that includes social networking information about the social agent.

4. The processor readable medium of claim 1, wherein the sharing card further comprises at least one selector icon configured to enable the recipient to share at least a portion of the playlist.

5. The processor readable medium of claim 1, wherein identifying the social agent further comprises identifying the social agent based in part on a communication's plan employed by the social agent, or an amount of sharing of multimedia content that the social agent has done within a defined period of time.

6. The processor readable medium of claim 1, wherein identifying a recipient of the playlist further comprises automatically identifying the recipient based on at least one of a degree of separation between the social agent and the recipient, a membership in a group, or a membership in an activity.

7. A method for managing a mobile device to manage multimedia content over a network, comprising:
identifying a social agent for use in virally sharing multimedia content;
providing to the social agent an application useable to manage a playlist associated with multimedia content;
automatically identifying a recipient for the playlist based in part on a social network associated with the recipient and the social agent;
sharing the playlist with the recipient, wherein the playlist is embodied within a sharing card; and
if the recipient plays at least one multimedia content item indicated within the playlist, providing the social agent with a reward.

8. The method of claim 7, wherein sharing the playlist further comprises:
sending a message to the recipient, wherein the message includes a link to an application;
enabling the recipient to access the application, wherein the application enables the recipient to view the sharing card and to further access the playlist of multimedia content.

9. The method of claim 7, wherein the playlist further comprises a plurality of playlists, each playlist within the plurality being configured and arranged to include items within one of following: music, photographs, videos, or ringtones.

10. The method of claim 7, wherein providing the social agent with a reward, further comprises restricting a number of times the recipient may receive the reward for sharing of the same multimedia content with the playlist.

11. The method of claim 7, wherein the sharing card further comprises:
n-sides, wherein a first side of the n-sided sharing card includes at least one graphic or message from the social agent; and
at least one other side of the n-sided sharing card includes the playlist that enables the recipient to select or rate at least one multimedia content item identified within the playlist.

12. A modulated data signal configured to include program instructions for performing the method of claim 7.

13. A network device to manage a mobile sharing of multimedia content, comprising:
a transceiver to send and receive data over a network; and
a processor that is operative to perform actions, comprising:
identifying at least one social agent based in part on a profile, or an online behavior;
providing to the social agent access to a graphical user interface that enables the social agent to manage a playlist of multimedia content, and to select to share at least a portion of the playlist;
receiving indication from through the graphical user interface that at least a portion of the playlist is to be shared, and identifying a recipient for the portion playlist based in part on a social network associated with the recipient and the social agent;
providing to the recipient access to another graphical user interface that includes a display of a sharing card for managing the portion of the playlist, wherein the sharing card includes is an n-sided polygon and at least one side displays the playlist; and
if the recipient shares at least part of the social agent's playlist with another member of the social network, providing the social agent with another reward.

14. The network device of claim 13, wherein the graphical user interface is associated with a downloadable application.

15. The network device of claim 13, wherein providing the recipient access further comprises sending the recipient a text message that includes at least one of a link, or instructions to access the other graphical user interface.

16. The network device of claim 13, wherein the processor is operative to perform actions, further comprising:
enabling the recipient and the social agent to manage a super playlist that includes at least some multimedia content associated with the recipient or the social agent.

17. A system for managing multimedia content over a network, comprising:
a first mobile device that is configured and arranged to perform actions, including:
receiving an indication that a user of the first mobile device is designated as a social agent for sharing multimedia content;
receiving a downloadable application that is configured to enable the user to manage a playlist of the multimedia content;
enabling the user to select to share at least a portion of the playlist with a recipient; and
a network device that is configured to perform actions, including:
identifying the social agent;
providing the application to the first mobile device;
identifying the recipient, in part, based on a social networking relationship between the recipient and the social agent;
proving a message to the recipient that the social agent would like to share multimedia content with the recipient;
providing the application to a second mobile device associated with the recipient; and
if the recipient plays at least one multimedia content item indicated within the playlist, providing the social agent with a reward.

18. The system of claim 17, wherein the application enables the recipient to access a sharing card that enables access to the shared multimedia content.

19. The system of claim 17, wherein the application enables the recipient to further share at least a portion of the received playlist, and
If the recipient shares at least one multimedia content item within the playlist, providing another reward to the social agent.

20. The system of claim 17, wherein identifying the social agent further comprises identifying the social agent based in part on at least one of an online social networking behavior, a communications plan, or a solicitation.
